(19) United States
(12) Patent Application Publication
(10) Pub. No.: US 2017/0346837 A1
(43) Pub. Date: Nov. 30, 2017

(54) REAL-TIME SECURITY MODIFICATION AND CONTROL

(71) Applicant: Micro Focus Software Inc., Provo, UT (US)

(72) Inventors: Gulshan Govind Vaswani, Bangalore (IN); Rajesh Nagella, Bangalore (IN); Michael F. Angelo, Spring, TX (US)

(21) Appl. No.: 15/211,002

(22) Filed: Jul. 15, 2016

Related U.S. Application Data
(60) Provisional application No. 62/343,310, filed on May 31, 2016.

(51) Int. Cl. H04L 29/06

(52) U.S. Cl. CPC H04L 63/1416; H04L 63/0281; H04L 63/10

(57) ABSTRACT

A principal is authenticated for access to a resource and assigned access rights for an authenticated session with the resource. Activity of the principal is monitored during the session, analyzed in real-time, and assigned a security score. Actions of the principal can be denied based on comparison of the score to a threshold; the session can be terminated; a policy can be set to disconnect the principal from future authenticated sessions with the resource once the principal connects with the resource; and/or the action is denied but the principal is permitted to continue with the authenticated session with the resource. No changes are made to the principal's access rights assigned for the authenticated session.

This application claims the benefit of priority under 35 U.S.C. 119(e) to U.S. Provisional Patent Application Ser. No. 62/343,310, filed May 31, 2016, which is incorporated herein by reference in its entirety.

### BACKGROUND

Network and computer security are of paramount concern in the industry today. It seems as if a week does not go by without some news about a network system being compromised. Moreover, this is not just private industry as governmental agencies experience security breaches with as much frequency as the private sector.

Organizations expend enormous time, money, and resources in order to protect their assets from security breaches. However, one troubling aspect about security breaches is that insider attacks are even more difficult to prevent. This is because employees of an organization are presumed to be responsible and acting within the scope of their employment responsibilities. Yet, employees with authorized access can cause the greatest amount of damage either intentionally or accidentally.

For example, an employee may be leaving an organization for a competitor to that organization and the employee may not have notified their current organization. During this time, the employee can access, and even compromise, confidential information from the organization. As another example, an employee may be fired but before that employee's network security can be revoked, the employee causes significant damage.

Furthermore, an employee may not intentionally act in a malicious manner to cause a security breach; in many cases innocuous and unintentional actions of a user with a high-level of security (privileges/rights/roles) can cause significant breaches. For example, this can happen by executing volatile operations within the organization's systems without the employee having the awareness or the expertise to realize what they were executing.

Typically, organizations handle security through authentication and assignment of access rights. When suspicious behavior is detected, alerts may be issued but the behavior itself is allowed when the behavior is authorized. There are no mechanisms in place to control behavior in real time when that behavior is permitted by the users' privileges and enforced by the underlying security system.

### SUMMARY

Various embodiments of the invention provide techniques for real-time security evaluation, modification, and control. In an embodiment, a method for real-time security evaluation, monitoring, and control is presented.

Specifically, in an embodiment, an action is identified as being attempted by a principal during an authenticated session with a resource. The principal has permission with an existing security mechanism of the resource for processing the action. Next, a security score is adjusted in real time based on the action during the authenticated session. Finally, a determination is made as to whether to permit the action to be processed by the resource during the authenticated session.

### BRIEF DESCRIPTION OF THE DRAWINGS

FIG. 1A is a diagram depicting an example architectural processing environment for practicing real-time security monitoring and control, according an example embodiment.

FIG. 1B is a diagram a method for real-time security monitoring and control, according to an example embodiment.

FIG. 2 is a diagram of another method for real-time security monitoring and control, according to an example embodiment.

FIG. 3 is a diagram of yet another method for real-time security monitoring and control, according to an example embodiment.

FIG. 4 is a diagram of a real-time security monitoring and control system, according to an embodiment.

### DETAILED DESCRIPTION

A “resource” includes a user, service, system, device, directory, data store, groups of users, files, combinations and/or collections of these things, etc. A “principal” is a specific type of resource, such as an automated service or user that at one time or another is an actor on another principal or another type of resource. A designation as to what is a resource and what is a principal can change depending upon the context of any given network transaction. Thus, if one resource attempts to access another resource, the actor of the transaction may be viewed as a principal. Resources can acquire and be associated with unique identities to identify unique resources during network transactions.

An “identity” is something that is formulated from one or more identifiers and secrets that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, Media Access Control (MAC) address, Internet Protocol (IP) address, device serial number, etc.

A “processing environment” defines a set of cooperating computing resources, such as machines (processor and memory-enabled devices), storage, software libraries, software systems, etc. that form a logical computing infrastructure. A “logical computing infrastructure” means that computing resources can be geographically distributed across a network, such as the Internet. So, one computing resource at network site X can be logically combined with another computing resource at network site Y to form a logical processing environment. Moreover, a processing environment can be layered on top of a hardware set of resources (hardware processors, storage, memory, etc.) as a Virtual Machine (VM) or a virtual processing environment.

The phrases “processing environment,” “cloud processing environment,” “hardware processing environment,” and the terms “cloud” and “VM” may be used interchangeably and synonymously herein.

Moreover, it is noted that a “cloud” refers to a logical and/or physical processing environment as discussed above.

A “service” as used herein is an application or software module that is implemented in a non-transitory computer-readable storage medium or in hardware memory as executable instructions that are executed by one or more hardware processors within one or more different processing environments. The executable instructions programmed in memory when executed by the hardware processors. A “service” can also be a collection of cooperating sub-services, such collection referred to as a “system.”

A single service can execute as multiple different instances of a same service over a network.

Various embodiments of this invention can be implemented as enhancements within existing network architectures and network-enabled devices.

Also, any software presented herein is implemented in (and reside within) hardware machines, such as hardware processor(s) or hardware processor-enabled devices (having hardware processors). These machines are configured and programmed to specifically perform the processing of the methods and system presented herein. Moreover, the methods and system are implemented and reside within a non-transitory computer-readable storage media or memory as executable instructions that are processed on the machines (processors) configured to perform the methods.

Of course, the embodiments of the invention can be implemented in a variety of architectural platforms, devices, operating and server systems, and/or applications. Any particular architectural layout or implementation presented herein is provided for purposes of illustration and comprehension of particular embodiments only and is not intended to limit other embodiments of the invention presented herein and below.

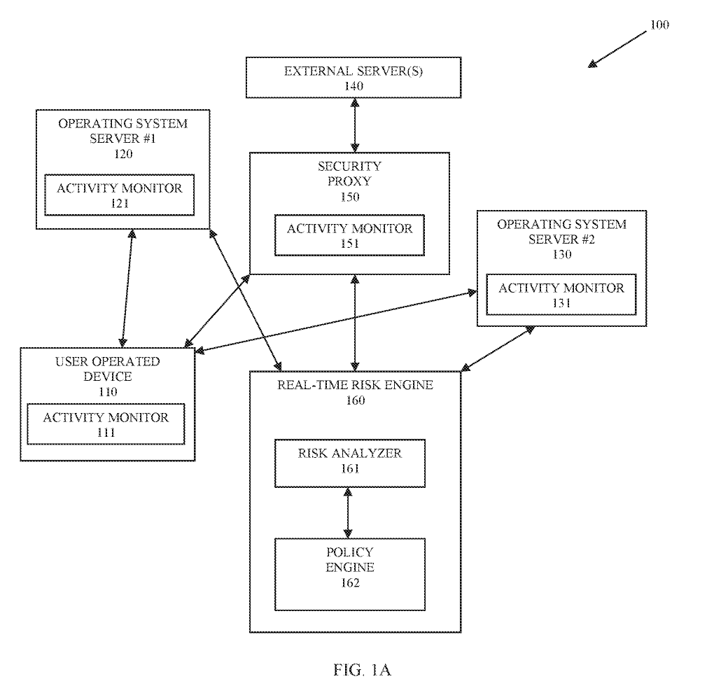

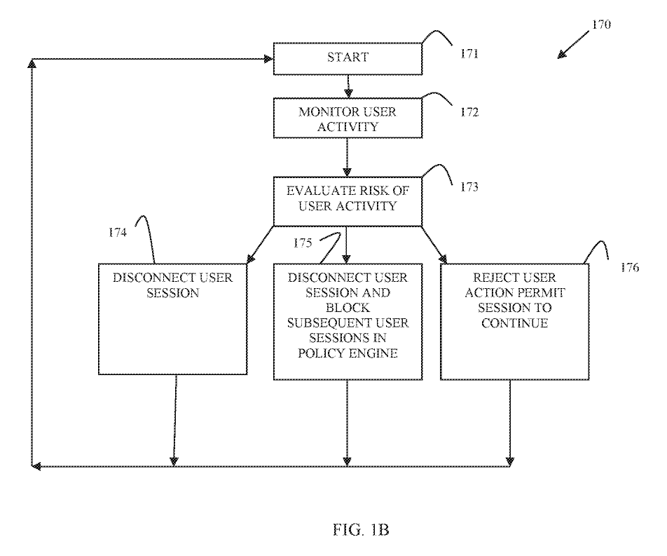

It is within this context that embodiments of the invention are now discussed within the context of the FIGS. 1A-1B and 2-4.

FIG. 1A is a diagram depicting an example architectural processing environment 100 for practicing real-time security monitoring and control, according an example embodiment. It is noted that the architectural processing environment 100 is presented as an illustrated embodiment and that other component definitions are envisioned without departing from the embodiments discussed herein. It is also to be noted that only those components necessary for comprehending the embodiments are presented, such that more or less components may be used without departing from the teachings presented herein.

The architectural processing environment 100 includes: a user-operated device 110, an operating system (OS) server #1 120, an OS server #3 130, one or more external servers 140, a security proxy 150, and a real-time risk engine server 160.

The user-operated device 110 may optionally include an activity monitor agent 111. Similarly, the OS server #1 120 may optionally include an activity monitor agent 121; the OS server #2 130 may optionally include an activity monitor agent 131; and the security proxy server 150 may optionally include an activity monitor agent 151.

Each activity monitor agent (111, 121, 131, and 151) monitors commands, operations, and/or actions taken by a principal (user or automated application) once the principal has successfully logged onto to a resource (such as the user-operated device 110, the OS server #1, the OS server #2, and/or the external server 140 and assigned access rights and permissions for accessing other resources (applications, directories, devices, files, etc.)

It is to be noted that at no time do the techniques herein modify the access rights or permissions assigned to the principal during the principal's authenticated session with the resource (110, 120, 130, and/or 140). That is, the existing security mechanisms of the resource (110, 120, 130, and/or 140) (the existing security mechanisms including privileges assigned within the existing security mechanisms) remains unchanged with the techniques presented herein; rather, the techniques presented herein augment and enhance the existing security mechanisms in real-time during the principal's authenticated session with the resource (110, 120, 130, and/or 140). Enhancement is achieved by evaluation of actions being attempted or being performed during the session to determine whether the actions (attempted or performed) are anomalies or dangerous to the underlying infrastructure or processing environments of the session.

The architectural processing environment 100 shows a variety of instances of the activity monitor (111, 121, 131, and 151) this is to illustrate a variety of architectural network locations from which the techniques of monitoring the principal's activities can be monitored during an authenticated session. These locations are not mutually exclusive such that all the depicted locations or some combination of the locations can be implemented.

For example, the principal may authenticate for access to the OS server #1 (resource) 120 for accessing other resources during a communication session between the principal and OS server #1 120. OS server #1 120 may be a LINUX-based web-accessible server. Similarly, the principal may authenticate for an authenticated session with OS server #2 120. OS server #2 130 may be a WINDOWS-based web-accessible server. The principal may also logon to a user-operated device 110 for an authenticated session with the user-operated device 110.

In still another case, the principal may authenticate for an authenticated session with a database server, such as a particular external server 140. Here, a security proxy server 150 is interposed between the data server 140 and the user operated device 110. In an embodiment, the security proxy server 150 is a transparent proxy to the external server 140 and the user-operated device 110. This arrangement illustrates that the activity monitor 151 can be implemented in a proxy 151 without modification to the resource (external database server 140) that the principal has an authenticated communication session with through the user-operated device 110. Furthermore, because the proxy 150 can see actions taken by the principal during the session with the database server 140, actions can be prevented when the security risk is deemed too high (as explained below) by the real-time risk engine 160.

It is to be noted that the proxy-based arrangement can be used with the OS servers 120 and 130 as well (although not depicted in the FIG. 1A). Additionally, the proxy-based arrangement can be used when the user-operated device includes an activity monitor 111 for monitoring principal actions during an authenticated login session by the principal with the user-operated device 110.

Therefore, as indicated before, a variety arrangements of the components can be implemented without departing from the teachings presented herein and below.

The activity monitor (111, 121, 131, and/or 151) monitors actions (commands, operations, actions, and, in some cases, keystrokes) taken by the principal during the authenticated session with the resource (110, 120, 130, and/or 150). Each action reported, in real time, to the real-time risk engine server 160.

The real-time risk engine server 160 includes a risk analyzer 161 and a policy engine 162. The analyzer 161 can aggregate actions into patterns (which may or may not be sequence dependent (dependent on the order in which each action is taken relative to other actions)). A pattern can include a single action (such as an operation flagged by the analyzer as high importance (e.g., accessing (such as through a query) an employee salary database, etc.)) and multiple actions of varying length. The analyzer 161 matches patterns in the policy engine 162. The policy engine 162 can include patterns based on an assigned role given to the principal when the principal authenticated for the authenticated session with the resource (110, 120, 130, and/or 140). The policy engine 162 may also include patterns associated to specific access rights associated with roles independent of role assignments (the access rights assigned when the principal authenticated for the authenticated session with the resource (110, 120, 130, and/or 140). The policy engine 162 may also include patterns for a specific principal identity that was assigned when the principal authenticated for the communication session with the resource (110, 120, 130, or 140).

In an embodiment, each pattern maintained by the policy engine 162 includes a value that is returned by the policy engine 162. The analyzer 161 maintains a running total for values returned by the policy engine 162, in real time during the principal's authenticated session with the resource (110, 120, 130, or 140). In an embodiment, the running total represents a real-time risk score for the principal's authenticated session with the resource (110, 120, 130, or 140).

The risk analyzer 161 compares the running total against pre-defined and dynamically adjustable threshold values (which may be maintained and retrieved from the policy engine 162 by the principal's assigned role, access permissions, and/or identity for the authenticated session with the resource (110, 120, 130, or 140)).

The comparison can result in a positive difference, a negative difference, or an equal value. Moreover, when there is a difference the degree of the difference can be within or outside a range (which may also be pre-defined and dynamically adjustable and retrievable from the policy engine 162).

Based on the difference and/or difference from the range, the risk analyzer determines whether to: 1) take no action and let the proposed action by the principal pass to the resource (110, 120, 130, or 140) for processing during the session, 2) instruct the corresponding activity monitor (111, 121, 131, or 151) to ignore a proposed action by the principal during the session (such that the resource (110, 120, 130, or 140) never sees and never processes the principal issued action), 3) instruct the activity monitor (111, 121, 131, or 151) to disconnect and terminate the principal's session with the resource (110, 120, 130, or 140), 4) perform 3) and also modify an entry in the policy engine 162 for the principal's identity that will instruct the risk analyzer 162 each time the principal subsequent authenticates for a communication session with the resource (110, 120, 130, or 140) to immediately disconnect that session (essentially blocking all principal access to the resource (110, 120, 130, or 140)).

The patterns for the activity of the principal can include patterns, such that as the principal performs actions the sum and/or sequence of specific sub-patterns previously detected can be noted to elevate the running total (risk score) for a session. For example, suppose a principal is detected accessing a confidential database in server 140 through communication of activity monitor 151 with the risk engine 160 during a session and subsequently the principal is detected as having sent an email through OS server #1 120 with the file. The policy engine 162 may include a pattern for performing the search and sending an email and provide an elevated score outside the threshold value. This can result in an instructing to instruct the activity monitor 121 of OS server #1 120 to block sending the email; alternatively, if the email is sent based on the risk score any second attempt may be blocked because the running risk score is outside the threshold with the principal's second attempt to send such an email.

The security mechanism and access rights of the resource (110, 120, 130, or 140) remains unchanged during a principal's session, but the risk manager 160 combined with the activity monitor (111, 121, 131, and/or 151) permit elevating a risk for the session and preventing access during the session that would otherwise be permitted based on the security mechanisms and assigned access rights for the principal during the session. This is done in real time with the continuing risk score being computed during the session and based on principal's previous activity within the session and current proposed and as of yet unexecuted activity (being temporarily blocked by the activity monitor (111, 121, 131, and/or 151) until an instruction is received from the risk engine 160. This permits a security mechanism for a resource (110, 120, 130 and/or 150) to be enhanced with real-time monitoring and action upon detection of suspicious activity and permitting the real-time remedial actions to be taken through the risk engine 160.

In an embodiment, the risk analyzer 161 and the policy engine 162 use a weighting scheme with the patterns for computing the risk score.

In an embodiment, the policy engine 162 maintains the patterns for the activity as a profile for access roles of principals and/or as a profile for a specific principal.

In an embodiment, the policy engine 162 maintains historical patterns for activity of the principal.

In an embodiment, the risk analyzer 161 can elevate a risk score based on a time-of-day, calendar date, and/or day of weak for a proposed activity of the principal. The elevation can be a weight that is applied to the risk score. In this manner, activity can be denied based on the dates and times they are attempted to be performed by a principal.

The risk engine 160 can also server to report patterns or activity for a plurality of principals or specific principals. So, the risk engine 160 can be used to audit activity, change security permissions of certain roles within an existing security mechanism based on the audited activity, and report activity that may be within a range of the threshold values.

Still further, even when the security mechanism for a given resource (110, 120, 130, and/or 140) is not modified, a given principal can be blocked from access to that resource (110, 120, 130, and/or 140) by the risk engine 160 (as discussed above). Here, the policy engine 162 is updated by the risk analyzer 161 such that each time the principal successfully authenticates for access to a resource (110, 120, 130, or 140), the activity monitor (111, 121, 131, or 151) is instructed to disconnect and block the session. This type of update to the policy engine 162 can be reported to security personnel associated with the security mechanism for manual evaluation and inspection.

FIG. 1B is a diagram a method 170 for real-time security monitoring and control, according to an example embodiment. The method 200 is implemented as one or more software modules (herein after referred to as “real-time security manager”). The real-time security manager is represented by executable instructions residing in a non-transitory computer-readable medium and/or memory, and the executable instructions executed by one or more hardware processors or a processor-enabled device.

In an embodiment, the processor-enabled device is a hardware server.

In an embodiment, the processor-enabled device is one or more of: the OS server #1 120, the OS server #2, the security proxy (server) 150, and/or the user-operated device 121.

In an embodiment, the real-time security manager is a combination of the components 111, 121, 131, 151, and 160-162.

At 171, the real-time security manager is initiated for processing. This entails starting at least one activity monitor (111, 121, 131, and/or 151) and the risk engine 160.

At 172, the real-time security manager monitors the user activity through the activity monitor (111, 121, 131, and/or 151) and interaction with the risk engine 160. Monitoring occurs when the principal (user) is detected as having successfully logged into a resource (110, 120, 130, or 140) for a communication session.

At 173, the real-time security manager evaluates the security risk of the user (principal) activity during the communication session with the resource (110, 120, 130, or 140). In an embodiment, patterns of past user activity and current activity during the session are assembled by the risk analyzer 161 and values obtained for the patterns from the policy engine 162 for purposes of maintaining a running risk score for session and any currently proposed action (activity) of the user with the resource during the session. The risk score is then compared to a threshold for determining whether to process one of 174-176.

When the comparison indicates that processing at 174 is to be performed, the real-time security manager disconnects the user session with the resource (110, 120, 130, or 140).

When the comparison indicates that processing at 175 is to be performed, the real-time security manager disconnects the user session and blocks subsequent user sessions with the resource (110, 120, 130 or 140) in the policy engine 162.

When the comparison indicates that processing at 176 is to be performed, the real-time security manager rejects the proposed user action within the session but permits the session to continue (without disconnection the session). Here, the risk analyzer 161 instructs the corresponding activity monitor (111, 121, 131, or 151) to not pass the proposed user action to the resource (110, 120, 130, or 140) during the session, such that the resource (110, 120, 130 or 140) and the security mechanism of the resource (110, 120, 130 or 140) never sees the proposed action (which would be permissible by the security mechanism based on the authenticated session of the user with the resource (110, 120, 130 or 140)).

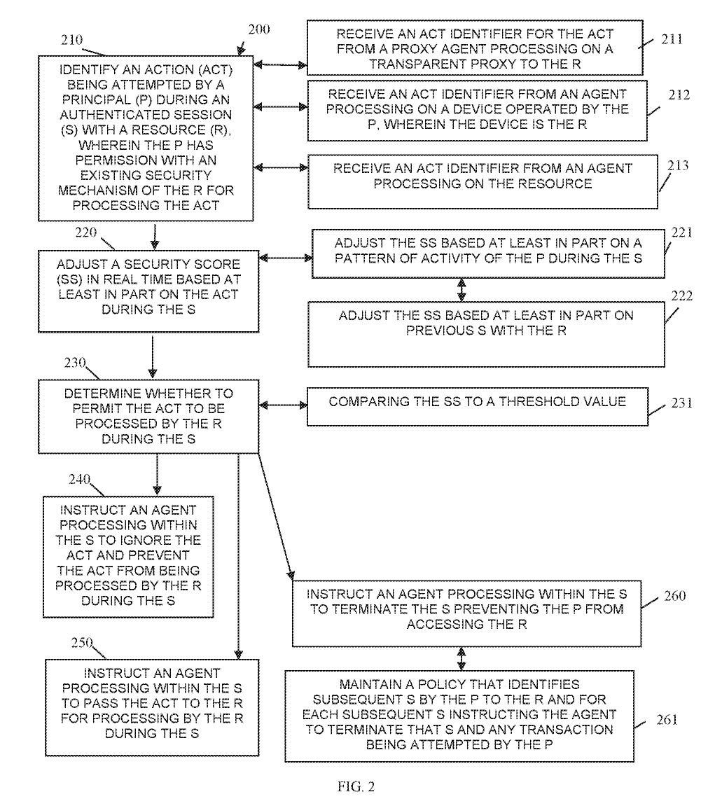

FIG. 2 is a diagram of another method 200 for real-time security monitoring and control, according to an example embodiment. The method 200 is implemented as one or more software modules (herein after referred to as “security risk engine”). The security risk engine is represented as executable instructions that are implemented, programmed, and resides within memory and/or a non-transitory machine-readable storage media; the executable instructions execute on one or more hardware processors of one or more network devices and have access to one or more network connections associated with one or more networks. The networks may be wired, wireless, or a combination of wired and wireless.

In an embodiment, security risk engine is the security risk manager 162.

In an embodiment, the security risk manager is the method 170.

In an embodiment, the network device that executes the security risk engine is a server.

In an embodiment, the network device that executes the security risk engine is a cloud processing environment.

At 210, the security risk engine identifies an action being attempted by a principal during an authenticated session with a resource. The principal has permissions with an existing security mechanism of the resource for processing the action being attempted.

In an embodiment, the principal is one of: a user and an automated service/application processing within an environment of the user during the authenticated session.

In an embodiment, the principal operates the user-operated device 110. In an embodiment, the user-operated device is one of: a laptop computer, a tablet, a desktop computer, a mobile phone, and a wearable processing device.

In an embodiment, at 211, the security risk engine receives an action identifier for the attempted action from a proxy agent processing on a transparent proxy to the resource. In an embodiment, the proxy agent is the activity monitor 151 and the transparent proxy is the security proxy 150.

In an embodiment, at 212, the security risk engine receives an action identifier for the attempted action from an agent processing on a device operated by the principal. Here, the device is the user-operated device 110.

In an embodiment, at 213, the security risk engine receives an action identifier for the attempted action from an agent processing on the resource. In an embodiment, the resource is one of: 120, 130, and 140.

At 220, the security risk engine adjusts a security score in real time based at least in part on the attempted action during the authenticated session. The manner in which the security score can be calculated was presented above with the discussion of the FIG. 1A. The security score is a continuing running score maintained during the session. It is also noted that some actions during the authenticated session may lower the security score, such that the score does not have to continually rise during the session. The policy engine 162 provides the conditions and adjustments in the score either upward or downward during the authenticated session.

In an embodiment, at 221, the security risk engine adjust the security score based at least in part on a pattern of activity of the principal during the authenticated session. The pattern can include sub-patterns subsumed into a more condensed higher-level pattern of activity. Moreover, the pattern may include sequence dependent actions (ordered in a predefined manner) and/or the pattern may include sequence independent actions.

In an embodiment of 221 and at 222, the security risk engine adjusts the security score based at least in part on a historical pattern of activity of the principal for previous authenticated sessions with the resource. The pattern may also be represented as a profile. In an embodiment, the profile is specific to the principal. In an embodiment, the profile is specific to a security role that the principal was assigned when the principal authenticated for the session. In an embodiment, the profile is specific to access rights assigned to the principal when the principal authenticated for the session. In an embodiment, the pattern is a plurality of patterns one associated with the principal, one associated with the resource, one associated with the security role, and/or one associated with the access rights or some combination of the access rights.

At 230, the security risk engine determines whether to permit the attempted action to be processed by the resource during the authenticated session. This can be done based on a comparison mechanism of the running security score against one or more predefined threshold values and the difference being, perhaps, further compared against a range of values. This was described above with reference to the FIG. 1A.

In an embodiment, at 231, the security risk engine compares the security score to a threshold value or set of threshold values (as discussed above).

According to an embodiment, at 240, the security risk engine instructs an agent processing with the authenticated session to ignore the attempted action and prevent the attempted action from being processed or seen by the resource during the authenticated session. This is a situation where the comparison determined that the attempted action represents suspicious activity of the principal and should be forbidden even though the access rights of the principal, as assigned by the existing security mechanism of the resource, would otherwise permit the principal to process the attempted action during the session with the resource.

In another case, at 250, the security risk engine instructs an agent processing within the authenticated session to pass the attempted action to the resource for processing by the resource during the session. This is a situation where the comparison of the security score against a threshold or set of threshold determined that the attempted action was acceptable for being processed by the resource. Again, this determination by the security risk engine is done independent of and in addition to what the security mechanism for the resource does (enhanced and augmented security through the security risk engine).

In still another case, at 260, the security risk engine instructs an agent processing within the authenticated session to terminate the authenticated session, thereby preventing the principal from any further interaction with the resource or any further actions within the session.

In an embodiment of 260 and at 261, the security risk engine maintains a policy that identifies subsequent session by the principal to the resource and for each subsequent session, the security risk engine instructs the agent to terminate each subsequent session before the principal can perform any action within the subsequent session other than successfully log in and authenticated through the existing security mechanism of the resource.

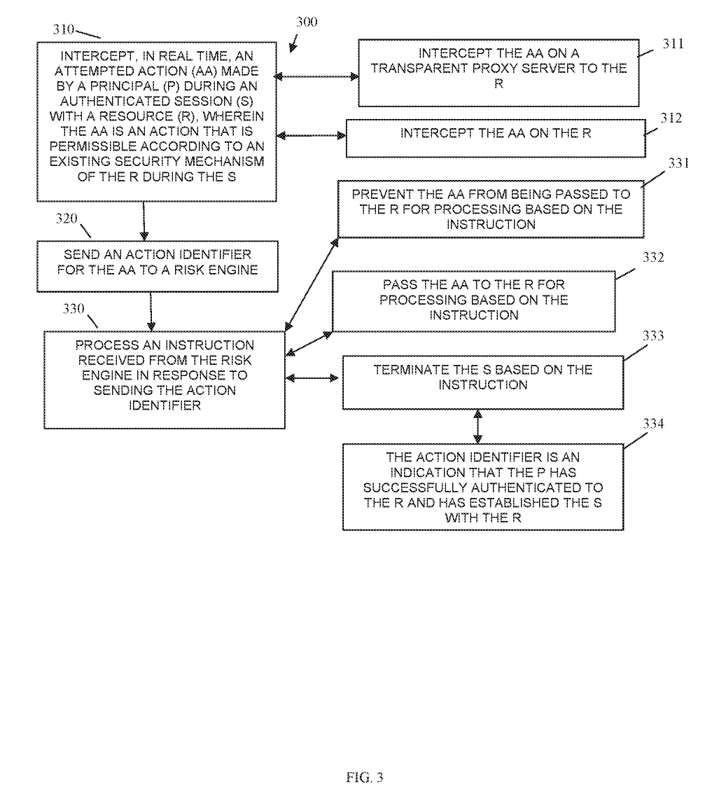

FIG. 3 is a diagram of yet another method 300 for real-time security monitoring and control, according to an example embodiment. The method 300 is implemented as one or more software module(s) (herein after referred to as “security monitoring agent”) on one or more hardware devices. The security monitoring agent is represented as executable instructions that are implemented, programmed, and resides within memory and/or a non-transitory machine-readable storage medium; the executable instructions execute on one or more hardware processors of the one or more hardware devices and have access to one or more network connections associated with one or more networks. The networks may be wired, wireless, or a combination of wired and wireless.

In an embodiment, the security monitoring agent is one or more of: the activity monitors 111, 121, 131, and/or 151. In an embodiment, different independent instances of the security monitoring agent security monitoring agent process on multiple devices (resources) and interact with the security risk engine 160.

In an embodiment, the hardware device that executes the security monitoring agent is one or more of 110, 120, 130, and/or 150.

In an embodiment, the hardware device that executes the security monitoring agent is a transparent proxy server.

At 310, the security monitoring agent intercepts, in real time, an attempted action made by a principal during an authenticated session between the principal and a resource. The attempted action is an action that is permissible according to an existing security mechanism of the resource during the session. In an embodiment, the attempted action is generated as a successful login performed by the principal with the existing security mechanism once successfully logged into the resource. That is, the security monitoring agent generates the attempted action as a special action that the principal has already performed to indicate to the security risk engine 160 that the principal has an authenticated session established with the resource.

In an embodiment, at 311, the security monitoring agent intercepts the attempted action on a transparent proxy server to the resource. In an embodiment, the transparent proxy server is the security proxy 150.

In an embodiment, at 312, the security monitoring agent intercepts the attempted action on the resource. In an embodiment, the resource is one of: 110, 120, 130, and 140.

At 320, the security monitoring agent sends an action identifier for the attempted action to a risk engine. In an embodiment, the risk engine is the security risk engine 160.

At 330, the security monitoring agent processes an instruction received from the risk engine in response to sending the action identifier. That is, the risk engine responds to receipt of the action identifier with an instruction.

In an embodiment, at 331, the security monitoring agent prevents the attempted action from being passed to the resource as a response from the risk engine and in response to the security monitoring agent sending the action identifier. This is a situation where the risk engine is instructing the security monitoring agent to not permit the resource to process the attempted action based on the risk engine's determination that the attempted action is suspicious and requires enhanced security that the existing security mechanism for the resource would otherwise permit as acceptable for the principal during the authenticated session (the access rights of the principal or security role of the principal assigned during login by the existing security mechanism permits the attempted action).

In another case, at 332, the security monitoring agent passes the attempted action to the resource for processing based on the instruction. This is a situation where the risk engine determines that the attempted action does not warrant any blocking by the security monitoring agent. However, the additional security processing is still performed by the security monitoring agent through interaction with the security monitoring agent in a manner that is transparent and augments the existing security mechanism of the resource even though the attempted action is permitted to proceed.

In an embodiment, at 333, the security monitoring agent terminates the authenticated session based on the instruction. Here, the risk engine determines that the session between the principal and the resource warrants termination based on the action identifier.

In an embodiment of 333 and at 334, the security monitoring agent sends the action identifier as a special action to the risk engine for purposes of alerting the risk engine that the principal has successfully established an authenticated session with the resource (this was discussed above). This is a situation, where the principal is continually and subsequently logged out of the authenticated session by the security monitoring agent based on instruction from the risk engine.

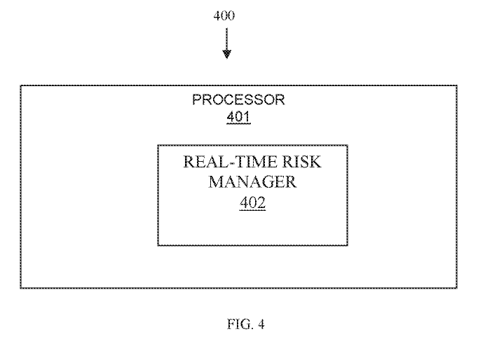

According to an embodiment, at 340, the security monitoring agent interacts with the FIG. 4 is a diagram of a real-time security monitoring and control system 400, according to an embodiment. Various components of the real-time security monitoring and control system 400 are software module(s) represented as executable instructions, which are programmed and/or reside within memory and/or non-transitory computer-readable storage media for execution by one or more hardware devices. The components and the hardware devices have access to one or more network connections over one or more networks, which are wired, wireless, or a combination of wired and wireless.

In an embodiment, the real-time security monitoring and control system 400 implements, inter alia, the processing depicted in the FIGS. 1A-1B and 2. Accordingly, embodiments discussed above with respect to the FIGS. presented herein and above are incorporated by reference herein with the discussion of the real-time security monitoring and control system 400.

The real-time security monitoring and control system 400 includes a processor 401 and a real-time risk manager 402.

In an embodiment, the processor 401 is part of a server.

In an embodiment, the processor 401 is part of a cloud processing environment.

The real-time risk manager 402 is configured and adapted to: execute on the processor 401, monitor principal actions attempted during an authenticated session between the principal and a resource, and provide additional security for the actions that would otherwise be permissible by an existing security mechanism of the resource during the authenticated session for the principal.

In an embodiment, the real-time risk manager 402 is the security risk engine 160.

In an embodiment, the real-time risk manager 402 is the method 200 of the FIG. 2.

In an embodiment, the real-time risk manager 402 is a combination of the security risk engine 160 and the method 200 of the FIG. 2.

According to an embodiment, the real-time risk manager 402 is further configured and adapted to: instruct an agent processing within the authenticated session to one of: a) prevent a particular one of the actions from being passed for processing by the resource, and b) terminate the authenticated session.

In an embodiment, the resource is one of: 110, 120, 130, and 140.

In an embodiment, the agent is one or more of: 111, 121, 131, and 151.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
identifying an action being attempted by a principal during an authenticated session with a resource, wherein the principal has permission with an existing security mechanism of the resource for processing the action;
adjusting a security score in real time based at least in part on the action during the authenticated session; and
determining whether to permit the action to be processed by the resource during the authenticated session.

2. The method of claim 1 wherein identifying further includes receiving an action identifier for the action from a proxy agent processing on a transparent proxy to the resource.

3. The method of claim 1, wherein identifying further includes receiving an action identifier from an agent processing on a device operated by the principal, wherein the device is the resource.

4. The method of claim 1, wherein identifying further includes receiving an action identifier from an agent processing on the resource.

5. The method of claim 1, wherein adjusting further includes adjusting the security score based at least in part on a pattern of activity of the principal during the authenticated session.

6. The method of claim 5, wherein adjusting further includes adjusting the security score based at least in part on previous authenticated sessions with the resource.

7. The method of claim 1, wherein determining further includes comparing the security score to a threshold value.

8. The method of claim 1 further comprising, instructing an agent processing within the authenticated session to ignore the action and prevent the action from being processed by the resource during the authenticated session and leaving existing security permissions assigned by the existing security mechanism unchanged when ignoring and preventing the action.

9. The method of claim 1 further comprising, instructing an agent processing within the authenticated session to pass the action to the resource for processing by the resource during the authenticated session.

10. The method of claim 1 further comprising, instructing an agent processing within the authenticated session to terminate the authenticated session preventing the principal from accessing the resource.

11. The method of claim 10 further comprising, maintaining a policy that identifies subsequent authenticated sessions by the principal to the resource and for each subsequent authenticated session instructing the agent to terminate that authenticated session and any transaction being attempted by the principal.

12. A method, comprising:
intercepting, in real time, an attempted action made by a principal during an authenticated session with a resource, wherein the attempted action is an action that is permissible according to an existing security mechanism of the resource during the authenticated session;
sending an action identifier for the attempted action to a risk engine; and
processing an instruction received from the risk engine in response to sending the action identifier.

13. The method of claim 12, wherein intercepting further includes intercepting the attempted action on a transparent proxy server to the resource.

14. The method of claim 12, wherein intercepting further includes intercepting the attempted action on the resource.

15. The method of claim 12, wherein processing further includes preventing the attempted action from being passed to the resource for processing based on the instruction.

16. The method of claim 12, wherein processing further includes passing the attempted action to the resource for processing based on the instruction.

17. The method of claim 12, wherein processing further includes terminating the authenticated session based on the instruction.

18. The method of claim 17, wherein the action identifier is an indication that the principal has successfully authenticated to the resource and has established the authenticated session with the resource.

19. A system, comprising:
a processor;
a real-time risk manager configured and adapted to: i) execute on the processor, ii) monitor principal actions attempted during an authenticated session between the principal and a resource, and iii) provide additional security for the actions that would otherwise be permissible by an existing security mechanism of the resource during the authenticated session for the principal.

20. The system of claim 19, wherein real-time risk manager is further configured and adapted, in iii), to: instruct an agent processing within the authenticated session to one of: a) prevent a particular one of the actions from being passed for processing by the resource, and b) terminate the authenticated session.
